(19) United States
(12) Patent Application Publication
(10) Pub. No.: US 2020/0118220 A1
(43) Pub. Date: Apr. 16, 2020

(54) AUTOMATED CUSTOMER INTEREST PROCESSING IN A CUSTOMER RELATIONSHIP MANAGEMENT (CRM) APPLICATION

(71) Applicant: SugarCRM Inc., Cupertino, CA (US)

(72) Inventors: Steve Byrne, Vancouver, WA (US); Rich Green, Los Altos Hills, CA (US); Eonju Lee, Cupertino, CA (US); Joseph Mao, Sunnyvale, CA (US); Brian Ng, Santa Clara, CA (US); Andreas Sandberg, Pacifica, CA (US); Zac Sprackett Sprackett, Kanata (CA)

(21) Appl. No.: 16/157,051

(22) Filed: Oct. 10, 2018

(51) Int. Cl. G06Q 50/00; G06F 17/30

(52) U.S. Cl. CPC G06Q 50/01; G06F 17/30864

(57) ABSTRACT

Embodiments of the invention provide a method, system and computer program product for automated customer interest processing in a customer relationship management (CRM) application. In an embodiment of the invention, a method for automated customer interest processing in a CRM application includes establishing a communicative connection between a CRM application executing in memory of a host computing system and different feeds of different social media web sites and storing customer information of one or more customers of the CRM application in memory of the host computing system, which includes one or more customer social media profiles of each of the customers. The method further includes monitoring customer social media data of the customer social media profiles and associated posts and, responsive to detecting a personal interest in the social media data, indicating the personal interest of the customer in the customer information of the customer.

### BACKGROUND OF THE INVENTION

### Field of the Invention

The present invention relates to CRM and more particularly to customer communication in CRM.

### Description of the Related Art

CRM refers to the interaction that a business entity enjoys with its customers, whether the business entity provides sales or services to the customer. CRM is often thought of as a business strategy that enables business managers to understand the customer, to retain customers through better customer experience, to attract new customers, increase profitability and to decrease customer management costs. In real terms, however, CRM systems are used specifically to manage business contacts, clients, contract wins and sales leads. As such, CRM solutions provide the end user with the customer business data necessary to provide services or products desired by the customers, to provide better customer service, to cross-sell and to up-sell more effectively, to close deals, retain current customers and understand the identity of the customer.

CRM provides an indispensable tool for product and service providers to manage the customer experience before, during and long after the sale has closed. The ability to manage all aspects of the customer experience largely depends upon maintaining a line of communication between the customer and the product or service provider. Not only is this line of communication important for closing the sale and future sales for that specific customer, the line of communication is important for generating referrals from that same customer. Thus, it is imperative that the product or service provider contacts the customer on a regular basis to keep their customer satisfied.

In contacting the customer, the product or service provider will often want to create a personal relationship with the customer, so that the customer is more likely to think of that product or service provider for future purchases and referrals. In order to foster a personal relationship, the product or service provider is inclined to learn more about the personal interests of that specific customer, such as their favorite sports team, whether they have pets, etc. Thus, the product or service provider is able to become more familiar with the customer on a more personal level to develop their personal relationship and, at the same time, may have product or service offerings based on the specific personal interests of that customer. However, developing a personal relationship with the customer and learning the personal interests of the customer is often a long, complicated and extremely subjective process, as the customer will likely not immediately disclose their personal interests to the products or service provider.

### BRIEF SUMMARY OF THE INVENTION

Embodiments of the present invention address deficiencies of the art in respect to customer communication in CRM and provide a novel and non-obvious method, system and computer program product for automated customer interest processing in a CRM application. In an embodiment of the invention, a method for automated customer interest processing in a CRM application includes establishing a communicative connection between a CRM application executing in memory of a host computing system and one or more different feeds of respectively different social media web sites over a computer communications network, as well as storing one or more customer information of one or more customers of the CRM application in memory of the host computing system wherein the customer information of each of the customers include one or more customer social media profiles of each of the customers. The method further includes monitoring customer social media data of the customer social media profiles and associated posts of the customer social media profiles in each of the social media web sites and, responsive to detecting a personal interest in the social media data, indicating the personal interest of the customer in the customer information of the customer associated with the social media data.

In another aspect of the embodiment, the social media data is determined to be a personal interest based upon a presence in the social media data of keywords present in a table of personal interests loaded into memory of the host computing system. In yet another aspect of the embodiment, the method further includes establishing a communicative connection between the CRM application executing in memory of the host computing system and one or more web sites over the computer communications network, monitoring the web sites for customer web publication data of the one or more customers of the CRM application based on the customer information and, responsive to detecting a personal interest in the web publication data, indicating the personal interest of the customer in the customer information of the customer associated with the web publication data. In even yet another aspect of the embodiment, the social media data and web publication data is determined to be a personal interest based upon a presence in the social media data and web publication data of keywords present in a table of personal interests loaded into memory of the host computing system.

In another embodiment of the invention, a CRM data processing system is configured for automated customer interest processing. The system includes a host computing system with one or more computers each with memory and at least one processor, a CRM application executing the memory of the host computing system and an automated customer interest processing module coupled to the CRM application. The module includes program code enabled to establish a communicative connection between the CRM application and one or more different feeds of respectively different social media web sites over a computer communications network and to store one or more customer information of one or more customers of the CRM application, which includes one or more customer social media profiles of each of the customers. The module further includes program code enabled to monitor customer social media data of the customer social media profiles and associated posts of the customer social media profiles in each of the social media web sites and, responsive to detecting a personal interest in the social media data, to indicate the personal interest of the customer in the customer information of the customer associated with the social media data.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for automated customer interest processing in a CRM application;

FIG. 2 is a schematic illustration of a CRM data processing system configured for automated customer interest processing; and,

FIG. 3 is a flow chart illustrating a process for automated customer interest processing in a CRM application.

### DETAILED DESCRIPTION OF THE INVENTION

Embodiments of the invention provide for automated customer interest processing in a CRM application. In accordance with an embodiment of the invention, customer information is stored in a data store coupled to a CRM application. In the customer information is the contact information of the customer, social media profiles from various social media web sites, and web publications associated with the customers. The web publications may be the customer's blog, personal website, professional website, news articles, or any online publication mentioning the customer. The CRM application monitors the web publications mentioning the customer and the customer's respective social media profiles and social media posts for keywords associated with their personal interests. Using Natural Language Processing (NLP), if the CRM application finds any of the keywords associated with personal interests in the customer's social media data and web publication data, the CRM application indicates the customer's personal interests with the relevant descriptive information regarding that personal interest in the customer information in the CRM application. The web publications and social media profile information of the customer may be input into the CRM application or the CRM application, in conjunction with NLP and a web search engine or a web crawler, may automatically find and obtain relevant personal interest information regarding the customer.

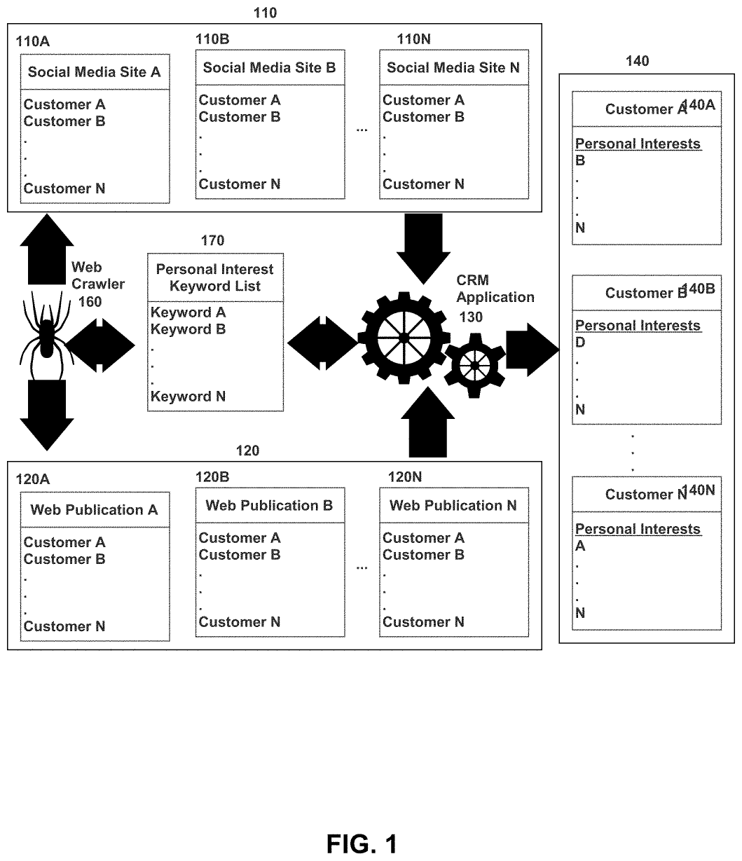

In further illustration, FIG. 1 is a pictorial illustration of automated customer interest processing in a CRM application. As shown in FIG. 1, a CRM application 130 is in communication with various social media web sites 110A, 110B, 110N and web publications 120A, 120B, 120N. The information of the customers of the CRM application 130 are stored in a database of the CRM application 130 with their respective contact information and respective social media profiles in each of the social media websites. The CRM application 130 may use NLP to determine whether the data contained in web publications 120 or social media data 110 describe any personal interests of the customers. Additionally, the CRM application 130 may store a personal interest keyword list or table 170, which indicate whether a specific word is associated with a personal interest.

The CRM application 130 determines whether the specific customer's social media profiles and associated posts in the social media web sites 110A, 110B, 110N mention any of the personal interests of the customer. The CRM application 130 also determines whether the web publications 120A, 120B, 120N regarding the customer mention any of the personal interest of the customer. The CRM application 130 then outputs the personal interests into the customer information 140 for the specific customer 140A, 140B, 140N based on the information mentioned in the web publications 120A, 120B, 120N and the customer's social media profiles and associated posts in the social media web sites 110A, 110B, 110N.

The social media profiles in the various social media websites 110A, 110B, 110N and the web publications 120A, 120B, 120N mentioning the customer may be input into the CRM application 130 by an end user of the CRM application. Alternatively, a web crawler 160 or web search engine may find and obtain the web publications 120A, 120B, 120N mentioning the customer and the customer's social media profiles in the various social media websites 110A, 110B, 110N based on other stored contact information in the customer information of the CRM application 130.

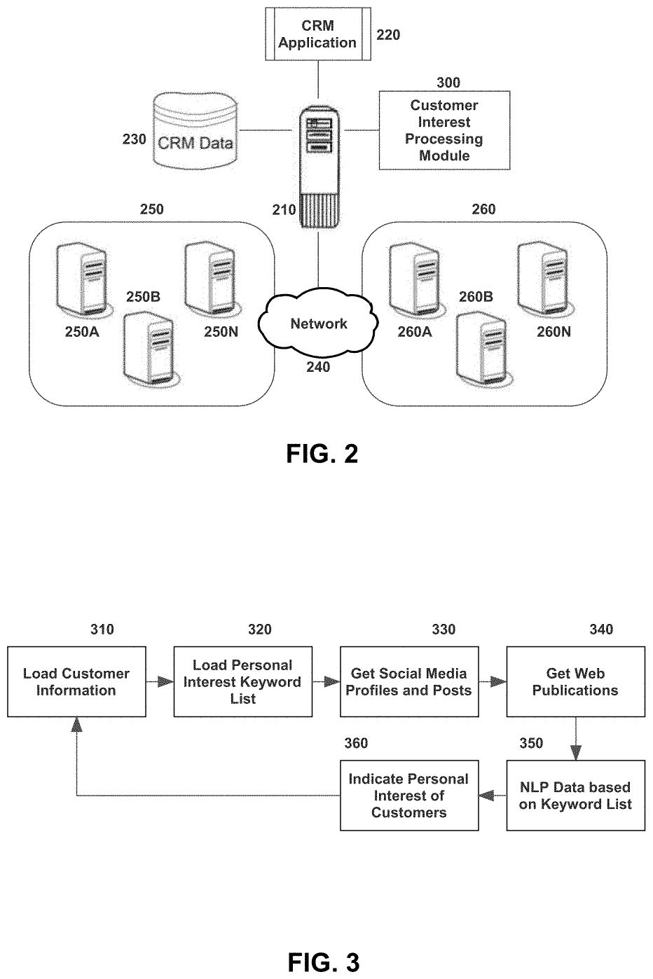

The process described in FIG. 1 is implemented in a data processing system. In further illustration, FIG. 2 schematically shows a CRM data processing system configured for automated customer interest processing. The system includes a host computing system 210 that includes one or more computers, each with memory and at least one processor. The host computing system 210 supports the operation of a CRM application 220 providing an interface through which different end users create, access, modify and delete CRM data in a CRM data store 230. In this regard, the end users access the CRM application 220 over computer communications network 240. The customer information with associated customer contact information, such as phone numbers for calling or texting and email addresses are stored in the CRM data store 230. Additionally, social media profile information of each of the customers, as well as web publications mentioning each of the customers are included in the respective customer information and stored in the CRM data store 230.

The host computing system 210 also is communicatively coupled over computer communications network 240 to a selection 250 of different social media web site servers 250A, 250B, 250N, as well as web publication web site servers 260A, 260B, 260N. Each of the different social media web site servers 250A, 250B, 250N supports the collection and publication of different communications or posts by different individuals in different feeds of different social media web site servers 250A, 250B, 250N providing different social media web sites. Each of the web publication web site servers 260A, 260B, 260N support the publication of information and may support the communications by different individuals in their respective servers 260A, 260B, 260N providing different web publication web sites. Importantly, an automated customer interest processing module 300 executes in the memory of the host computing system 210 in conjunction with the CRM application 220.

The automated customer interest processing module 300 includes computer program code that when executed in the memory of the host computing system, determines whether social media profiles and posts from the social media web site servers 250A, 250B, 250N associated with customers of the CRM application 220 mention any personal interest information of the customer. The automated customer interest processing module 300 also determines whether any web publications in the web publication web site servers 260A, 260B, 260N mention any personal interest information of the customer. If personal interest information is mentioned, the automated customer interest processing module 300 automatically updates the customer information in the CRM data store 230 to include the customer's personal interests in their respective customer information.

In even yet further illustration of the operation of the automated customer interest processing module 300, FIG. 3 is a flow chart illustrating a process for automated customer interest processing in a CRM application. Beginning in block 310, the customer information is loaded with their respective social media profile information and web publication information. In block 320, the personal interest keyword list is loaded that defines whether a word is related to a personal interest. In block 330, the social media profiles and posts from various social media web sites for the respective customer are obtained. In block 340, the web publications mentioning the respective customer are obtained. In block 350, NLP based on the personal interest keyword list is used to determine if the respective customer's social media information and web publication information mention any personal interests. If personal interests are mentioned, in block 360, the customer information is updated with the specific personal interests of the customer and relevant information regarding that personal interest. The process is then repeated for the various customers and also repeated periodically to update the personal interests of the each of the customers.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network. The computer readable program instructions may execute entirely on the user's computer, partly on the user's computer, as a stand-alone software package, partly on the user's computer and partly on a remote computer or entirely on the remote computer or server. Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for automated customer interest processing in a customer relationship management (CRM) application, the method comprising:
establishing a communicative connection between a CRM application executing in memory of a host computing system and one or more different feeds of respectively different social media web sites over a computer communications network;
storing one or more customer information of one or more customers of the CRM application in memory of the host computing system wherein the customer information of each of the customers comprise one or more customer social media profiles of each of the customers;
monitoring customer social media data of the customer social media profiles and associated posts of the customer social media profiles in each of the social media web sites; and
responsive to detecting a personal interest in the social media data, indicating the personal interest of the customer in the customer information of the customer associated with the social media data.

2. The method of claim 1, wherein the social media data is determined to be a personal interest based upon a presence in the social media data of keywords present in a table of personal interests loaded into memory of the host computing system.

3. The method of claim 1, further comprising:
establishing a communicative connection between the CRM application executing in memory of the host computing system and one or more web sites over the computer communications network;
monitoring the web sites for customer web publication data of the one or more customers of the CRM application based on the customer information; and
responsive to detecting a personal interest in the web publication data, indicating the personal interest of the customer in the customer information of the customer associated with the web publication data.

4. The method of claim 3, wherein the social media data and web publication data is determined to be a personal interest based upon a presence in the social media data and web publication data of keywords present in a table of personal interests loaded into memory of the host computing system.

5. A customer relationship management (CRM) data processing system configured for automated customer interest processing, the system comprising:
a host computing system comprising one or more computers each with memory and at least one processor;
a CRM application executing the memory of the host computing system; and,
an automated customer interest processing module coupled to the CRM application, the module comprising program code enabled to establish a communicative connection between the CRM application and one or more different feeds of respectively different social media web sites over a computer communications network, to store one or more customer information of one or more customers of the CRM application wherein the customer information of each of the customers comprise one or more customer social media profiles of each of the customers, to monitor customer social media data of the customer social media profiles and associated posts of the customer social media profiles in each of the social media web sites and, responsive to detecting a personal interest in the social media data, to indicate the personal interest of the customer in the customer information of the customer associated with the social media data.

6. The system of claim 5, wherein the social media data is determined to be a personal interest based upon a presence in the social media data of keywords present in a table of personal interests loaded into memory of the host computing system.

7. The system of claim 5, wherein the module further comprises program code enabled to establish a communicative connection between the CRM application and one or more web sites over the computer communications network, to monitor the web sites for customer web publication data of the one or more customers of the CRM application based on the customer information and, responsive to detecting a personal interest in the web publication data, to indicate the personal interest of the customer in the customer information of the customer associated with the web publication data.

8. The system of claim 7, wherein the social media data and web publication data is determined to be a personal interest based upon a presence in the social media data and web publication data of keywords present in a table of personal interests loaded into memory of the host computing system.

9. A computer program product for automated customer interest processing in a customer relationship management (CRM) application, the computer program product comprising a computer readable storage medium having program instructions embodied therewith, the program instructions executable by a device to cause the device to perform a method comprising:
establishing a communicative connection between a CRM application executing in memory of a host computing system and one or more different feeds of respectively different social media web sites over a computer communications network;
storing one or more customer information of one or more customers of the CRM application in memory of the host computing system wherein the customer information of each of the customers comprise one or more customer social media profiles of each of the customers;
monitoring customer social media data of the customer social media profiles and associated posts of the customer social media profiles in each of the social media web sites; and
responsive to detecting a personal interest in the social media data, indicating the personal interest of the customer in the customer information of the customer associated with the social media data.

10. The computer program product of claim 9, wherein the social media data is determined to be a personal interest based upon a presence in the social media data of keywords present in a table of personal interests loaded into memory of the host computing system.

11. The computer program product of claim 9, wherein the program instructions further comprise:
establishing a communicative connection between the CRM application executing in memory of the host computing system and one or more web sites over the computer communications network;
monitoring the web sites for customer web publication data of the one or more customers of the CRM application based on the customer information; and
responsive to detecting a personal interest in the web publication data, indicating the personal interest of the customer in the customer information of the customer associated with the web publication data.

12. The computer program product of claim 11, wherein the social media data and web publication data is determined to be a personal interest based upon a presence in the social media data and web publication data of keywords present in a table of personal interests loaded into memory of the host computing system.
